(19) United States
(12) Patent Application Publication
(10) Pub. No.: US 2011/0134088 A1
(43) Pub. Date: Jun. 9, 2011

(54) LIQUID CRYSTAL DISPLAY CAPABLE OF PROVIDING TWO SUB-GRAY LEVEL VOLTAGES TO PIXELS IN POLARITY REVERSED LOWS

(75) Inventors: SZ-HSIAO CHEN, Miao-Li County (TW); EDDY GIING-LII CHEN, Miao-Li County (TW); KAI-CHIEH CHAN, Miao-Li County (TW)

(73) Assignee: CHIMEI INNOLUX CORPORATION, Miao-Li County (TW)

(21) Appl. No.: 12/959,395

(22) Filed: Dec. 3, 2010

(30) Foreign Application Priority Data
Dec. 4, 2009 (CN) 200910310913.2

(51) Int. Cl. G09G 5/00; G09G 3/36

(52) U.S. Cl. 345/204; 345/87

(57) ABSTRACT

A liquid crystal display comprises a data driver, a scanning driver, and a pixel matrix. The pixel matrix is driven by the data driver and scanning driver, and the pixel matrix comprises a plurality of first pixels positioned in non-polarity reversed rows and a plurality of second pixels positioned in polarity reversed rows. The data driver provides a first gray level voltage signal for the first pixels, and provides a second gray level voltage signal for the second pixels. The second gray level voltage signal includes a first sub-gray level voltage and a second sub-gray level voltage which are sequentially outputted to the second pixels. An absolute value of the first sub-gray level voltage is greater than that of the second sub-gray level voltage, and the absolute value of the second sub-gray level voltage is the same with that of the first gray level voltage signal.

### BACKGROUND

1. Technical Field

The present disclosure relate to a liquid crystal displays (LCD).

2. Description of Related Art

LCDs have the advantages of portability, low power consumption, and low radiation, and thus are widely used in various portable information products, such as notebooks, personal digital assistants, video cameras, and the like.

A commonly used LCD includes two substrates and a liquid crystal layer with a plurality of liquid crystal molecules between the two substrates. In operation, a common voltage and gray level voltage signals are provided to the two substrates respectively such that an electric field generated by the two substrates tilts the liquid crystal molecules to desired angles. Accordingly, a light transmission of the LCD is controlled, and the LCD can display images.

However, the liquid crystal molecules of the LCD may be decayed or damaged when a special direction of the electric field provided to the liquid crystal layer is maintained for a long time. In order to protect the liquid crystal molecules from decay or damage, a plurality of polarity inversion driving methods are used in the LCD. The polarity inversion driving methods may include, for example, a dot inversion driving method and a line inversion driving method. The line inversion driving may further include a one-line inversion driving method, a two-line inversion driving method, and so on.

According to the two-lines inversion driving method, pixels in two adjacent rows (e.g., the first row and the second row) of the LCD have a same polarity, such as a first polarity, while pixels in next two adjacent rows (e.g., the third row and the fourth row) of the LCD have another same polarity, such as a second polarity which is reversed to the first polarity. Furthermore, the polarity of each pixel may be alternately changed during two consecutive frames, whereby the liquid crystal molecules can be protected from decay or damage. A difference between the gray level voltage and the common voltage is a voltage applied to a pixel. When the gray level voltage is greater than the common voltage, the voltage applied to a pixel has a positive polarity, and the gray level voltage is defined as a positive gray level voltage. When the gray level voltage is less than the common voltage, the voltage applied to a pixel has a positive polarity, and the gray level voltage is defined as a negative gray level voltage.

However, when all of the pixels of the LCD display a same gray level, there is a transmission loss under the transmission of the gray level voltage, and the transmission loss will become more and more larger as the gray level voltage being transmitted more and more farther. Thus, the gray level voltage is not an ideal square signal when transmitted, in other words, the positive gray level voltage will not turn to the negative gray level voltage or the negative gray level voltage will not turn to positive gray level voltage immediately in real transmission, but turning slowly. So, the voltage applied to each pixel in the ith (where i is a natural number, 2≦i≦L, where L is the total rows of the pixels, where L is also a natural number) row is lower than the voltage applied to the pixel in the (i+1)th row while the polarity of the pixel in the ith row is the same with the polarity of the pixel in the (i+1)th row but different with the polarity of the pixel in the (i−1)th row. Therefore, due to voltage delays of data lines, the LCD used the above-described driving method will display an image with a so called “odd-even-line phenomenon”. In detail, taking pixels of the third row and the fourth row as an example, because of voltage delays of data lines, gray level voltage signals applied to the pixels in the third row is lower than gray level voltage signals applied to the pixel in the fourth row. Accordingly, brightness of the third row and the fourth row will be different from each other. That is, the image displayed by the LCD may occur a brightness difference problem between the pixels in the odd and even rows. Thus, image quality of the LCD is adversely affected.

What is needed is to provide an LCD that can overcome the described phenomenon.

### SUMMARY

An aspect of the disclosure relates to a liquid crystal display, the liquid crystal display comprises a data driver, a scanning driver, and a pixel matrix. The pixel matrix is driven by the data driver and scanning driver, and the pixel matrix comprises a plurality of first pixels which are positioned in non-polarity reversed rows and a plurality of second pixels which are positioned in polarity reversed rows. The data driver provides a first gray level voltage signal for the first pixels, and provides a second gray level voltage signal for the second pixels. The second gray level voltage signal includes a first sub-gray level voltage and a second sub-gray level voltage which are sequentially outputted to the second pixels. An absolute value of the first sub-gray level voltage is greater than that of the second sub-gray level voltage, and the absolute value of the second sub-gray level voltage is the same with that of the first gray level voltage signal.

### BRIEF DESCRIPTION OF THE DRAWINGS

FIG. 1 is a partial circuit diagram of an LCD according to one embodiment of the present disclosure.

FIG. 2 illustrates polarity of pixels of the LCD of FIG. 1.

FIG. 3 illustrates a timing chart of the LCD of FIG. 1.

### DETAILED DESCRIPTION

Reference will now be made to the drawings to describe certain embodiments of the present disclosure in detail.

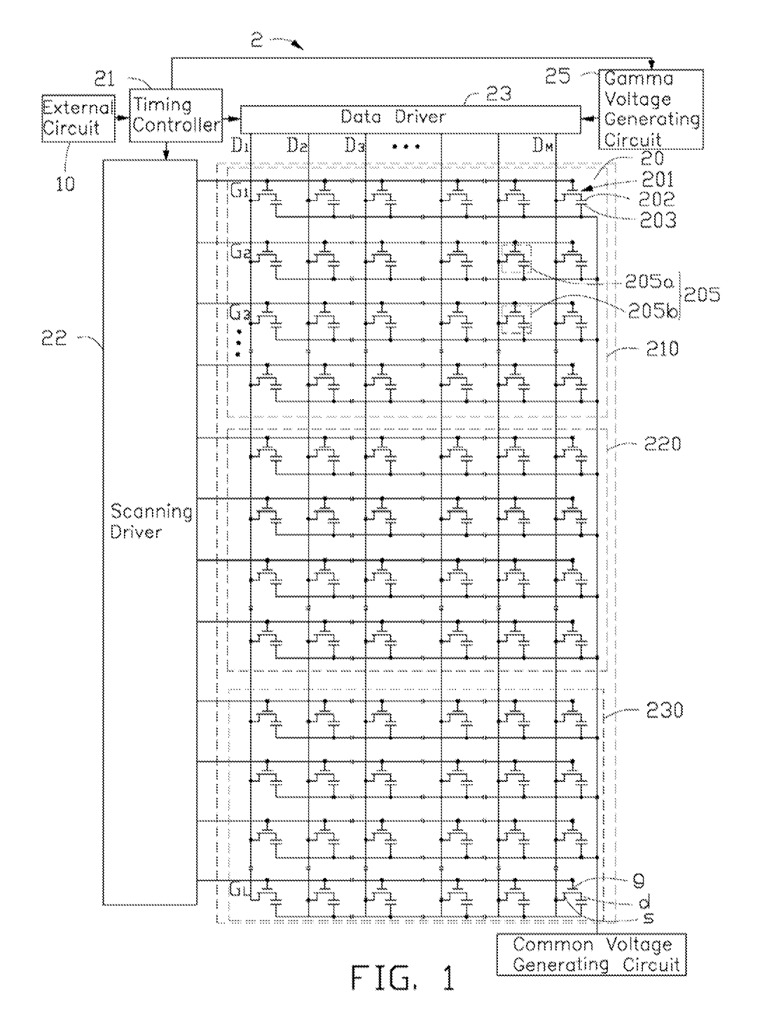

Referring to FIG. 1, a partial circuit diagram of the LCD 2 according to an embodiment of the present disclosure is shown. The LCD 2 includes a liquid crystal panel 20, a timing controller 21, a scanning driver 22, a data driver 23, a common voltage generating circuit 24, and a gamma voltage generating circuit 25. The liquid crystal panel 20 includes a plurality of parallel scanning lines G₁˜G_{L} (where L is a natural number, L>1), a plurality of parallel data lines D₁˜D_{M} (where M is also a natural number, M>1) perpendicular to the scanning lines G₁˜G_{L}, and a pixel matrix (not labeled) including a plurality of pixels 205 cooperatively defined by the crossing scanning lines G₁˜G_{L} and data lines D₁˜D_{M}. Each pixel 205 includes a thin-film transistor (TFT) 201, a pixel electrode 202, and a common electrode 203 opposite to the pixel electrode 202. A gate electrode (g) of the TFT 201 is electrically coupled to a corresponding one of the scanning lines G₁˜G_{L}, a source electrode (s) of the TFT 201 is electrically coupled to a corresponding one of the data lines D₁˜D_{M}, and a drain electrode (d) of the TFT 201 is electrically coupled to the pixel electrode 202. Further, the liquid crystal panel 20 can be divided into three parts along an extending direction of the data lines D₁˜D_{M}. Each part can have a same or different area, and each part includes at least one row pixels. The three parts can be correspondingly named as a first display area 210, a second display area 220 and a third display area 230. The first display area 210 is near the data driver 23, the third display area 230 is far away the data driver 23 and the second display area 220 is between the first display area 210 and the third display area 230. In one embodiment, the area of the first, second and third display areas 210, 220 and 230 are the same. In addition, the liquid crystal panel 20 can also be divided into four or more parts along an extending direction of the data lines D1˜DM.

The common voltage generation circuit 24 is configured to provide a common voltage (Vcom) to the common electrodes 203. The timing controller 21 is configured to receive image data provided by an external circuit (e.g., a video signal processing circuit) 10, and then provide control signals to the scanning driver 22, the gamma voltage generating circuit 25, and the data driver 23, and provide an image signal to the data driver 23. The gamma voltage generating circuit 25 is configured to provide a plurality of gamma voltages to the data driver 23. The scanning driver 22 is configured to provide scanning signals to the scanning lines G1˜GL so as to enable the TFTs 201. Each scanning signal provided by the scanning driver 22 is applied to the gate electrode of the TFT 201 via the corresponding scanning line GL. The data driver 23 is configured to output gray level voltage signals to the data lines D1˜DM according to the control signal, the image signal, and the gamma voltages. Each gray level voltage signal output by the data driver 23 is applied to the source electrode of the TFT 201 via the corresponding data line DM. When the TFTs 201 are turned on, the gray level voltage signals of the corresponding data lines can be provided to the corresponding pixel electrodes 202 via the TFTs 201, and each gray level voltage signal can be transmitted to the corresponding drain electrode of the TFT 201. The pixels display various gray levels according to the gray level voltage signals, so as to form an image. Furthermore, each of the gamma voltages is a polarity reversed signal. Specially, the gamma voltage greater than the common voltage is defined as a positive gamma voltage, and the gamma voltage less than the common voltage is defined as a negative gamma voltage.

To protect the liquid crystal molecules from decay or damage, a direction of an electric field generated in each pixel by the pixel electrode 202 and the common electrode 203 may be reversed periodically. To simplify the following description, when the gray level voltage signal provided to the pixel electrode 202 is greater than or equal to the common voltage provided to the common electrode 203, the gray level voltage signal is defined as a positive gray level voltage signal, and the pixel has a positive polarity this time. When the gray level voltage signal is less than the common voltage, the gray level voltage signal is defined as a negative gray level voltage signal, and the pixel has a negative polarity. When an absolute value of a voltage value of a positive gray level voltage signal is equal to that of a negative gray level voltage signal, the pixel 205 has a same gray level. The voltage value of the positive or negative gray level voltage signal is a voltage difference between the positive or negative gray level voltage signal and the common voltage signal.

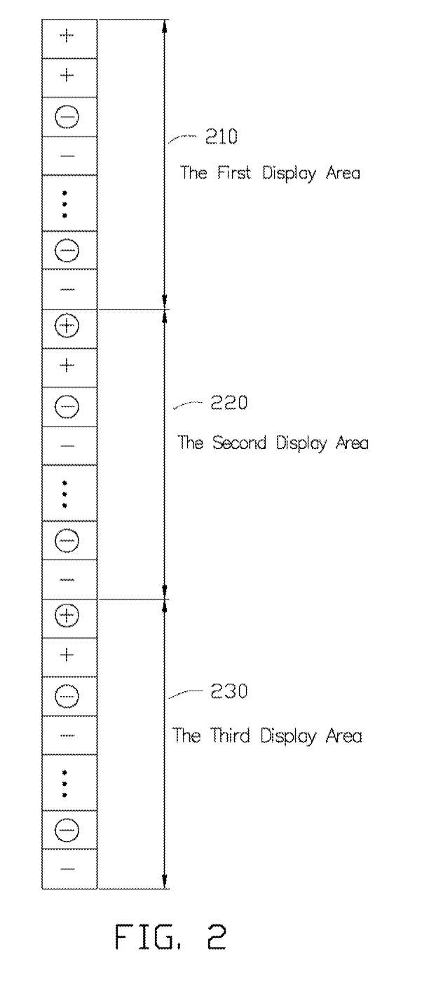

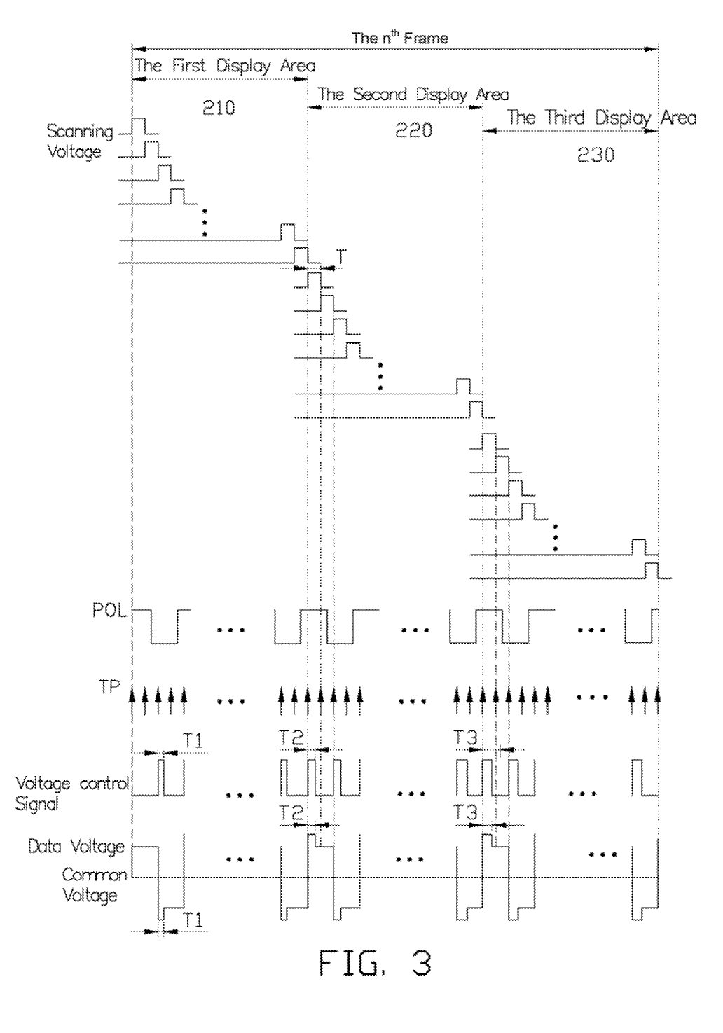

A two-line inversion driving method is used in the LCD 2. Referring to FIG. 2, the polarities of the pixels 205 of the LCD 2 of a column is shown. Referring to FIG. 3, a timing chart of the LCD 2 relative to FIG. 2 is shown. To simplify the following description, FIG. 2 only illustrates polarities of the pixels 205 in the first column. In the two-line inversion driving method, the pixels 205 of two adjacent rows (e.g., the first row and the second row) have a same polarity, such as a first polarity, and the pixels 205 of next two adjacent rows (e.g., the third row and the fourth row) have another same polarity, such as a second polarity which is reversed to the first polarity. The polarity of the each pixel 205 is alternately changed during two consecutive frames. In addition, the LCD 2 can also adopt other driving methods, for example, a (1+2)-line inversion driving method, a 2-line inversion driving method, for example.

In the pixel matrix, when the polarity of the pixels 205 in the ith (where i is a natural number, 2≦i≦L, where L is the total rows of the pixels and is also a natural number) row is same as that of the pixels in the (i+1)th row but reversed to that of the pixels in the (i−1)th row, the ith row of the pixel matrix is defined as a polarity inversed row. For example, the polarity of the pixels both in the ith row and the (i+1)th row is the first polarity, and the polarity of the pixels in the (i−1)th row is the second polarity, the ith row is the polarity inversed row. Except the polarity inversed rows, other rows of the pixel matrix are defined as non-polarity inversed rows. For example, in FIG. 2, the rows in which the pixels 205 labeled by circles are polarity inversed rows, and the rows in which the pixels 205 not labeled by circles are non-polarity inversed rows.

The following takes an nth frame image as an example to describe the operation of the LCD 2, where the nth frame image corresponds to an image with all of the pixels 205 of the liquid crystal panel 20 having a same gray level. Referring to FIG. 3, in operation, when the LCD 2 displays the nth frame image, the common voltage generation circuit 24 provides the common voltage to the common electrode 203. The timing controller 21 provides the image signal such as a reduced swing differential signal (RSDS), and control signals including a horizontal synchronizing signal, a vertical synchronizing signal, a polarity reversed signal POL, a voltage control signal, and a data refresh synchronizing signal TP. The horizontal synchronizing signal is then transmitted to the data driver 23. The vertical synchronizing signal is then transmitted to the scanning driver 22. The polarity reversed signal POL and the data refresh synchronizing signal TP are then transmitted to both of the data driver 23 and the gamma voltage generating circuit 25. The voltage control signal is then transmitted to the gamma voltage generating circuit 25.

In one embodiment, the polarity reversed signal POL is a continuous alternating square signal, and includes a positive value with a positive polarity and a negative value with a positive polarity. The data refresh synchronizing signal is a sampling signal, and is configured to sample polarities of the polarity reversed signal. The voltage control signal is a continuous alternating square signal, and includes a high level (logical 1) and a low level (logical 0). The voltage control signal is defined as a first voltage control signal when the voltage control signal is low level, and the voltage control signal is defined as a second voltage control signal when the voltage control signal is high level. In another embodiment, the voltage control signal can be defined as a first voltage control signal when the voltage control signal is high level, and the voltage control signal can be defined as a second voltage control signal when the voltage control signal is low level.

The scanning driver 22 receives the vertical synchronizing signal and provides scanning signals to enable the TFTs 201 in the first, second and third display areas 210, 220 and 230 sequentially.

As to each pixel 205a in the non-polarity reversed rows, the timing controller 21 provides the first voltage control signal to the gamma voltage generating circuit 25. The gamma voltage generating circuit 25 provides a first gamma voltage to the data driver 23 in response to the first voltage control signal. The data driver 23 provides a first gray level voltage signal to the pixel 205a in the non-polarity reversed row via the corresponding data line in response to the first gamma voltage. In detail, the data driver 23 may define the first gamma voltage as the first gray level voltage signal, and outputs the first gray level voltage signal to the pixel 205a in non-polarity reversed row via the corresponding data line.

As to each pixel 205b in the polarity reversed rows, the timing controller 21 sequentially provides the second voltage control signal and the first voltage control signal to the gamma voltage generating circuit 25. The gamma voltage generating circuit 25 provides a second gamma voltage to the data driver 23 in response to the second voltage control signal, and provides the first gamma voltage to the data driver 23 in response to the first voltage control signal. Further, the polarities of the first gamma voltage and the second gamma voltage are determined by the polarities sampled by the data refresh synchronizing signal. The data driver 23 provides a second gray level voltage signal to the data line in response to the second gamma voltage and the first gamma voltage.

Each second gray level voltage signal includes a first sub-gray level voltage corresponding to the second gamma voltage and a second sub-gray level voltage corresponding to the first gamma voltage. An absolute value of the first sub-gray level voltage is greater than that of the second sub-gray level voltage. Additionally, a ratio of an absolute value difference between the first sub-gray level voltage and the second sub-gray level voltage to an absolute value of the second sub-gray level voltage can be set as 20%. In detail, the data driver 23 may define the second gamma voltage and the first gamma voltage as the first sub-gray level voltage and the second sub-gray level voltage respectively, and sequentially outputs the first sub-gray level voltage and the second sub-gray level voltage to the corresponding pixel 205b in polarity reversed row via the corresponding data line. When the pixels 205a in the non-polarity reversed rows and the pixels 205b in the polarity reversed rows are the same gray level, an absolute value of the first gray level voltage signal corresponding to the pixel 205a is the same as that of the second sub-gray level voltage corresponding to the pixel 205b.

Further, in each frame period, a period of each TFT 201 which is turned on can be defined as T. As to each pixel 205b in the polarity reversed rows of the first display area 210, a period of the corresponding second voltage control signal can be defined as T1, and a period of the corresponding first voltage control signal can be defined as (T−T1). Accordingly, a ratio of T1 to T can be defined as a first duty ratio corresponding to the first display area 210, and a variation range of the first duty ratio can be from 0 to 100%. Correspondingly, a period of the first sub-gray level voltage output by the data driver is also T1, and a period of the second sub-gray level voltage is also (T−T1). Therefore, as to each pixel 205b in the polarity reversed rows of the first display area 210, a duty ratio of the corresponding first sub-gray level voltage in the second gray level voltage is the same with the first duty ratio, and a variation range of the duty ratio of the corresponding first sub-gray level voltage in the second gray level voltage can also be from 0 to 100%. As to each pixel 205a in the non-polarity reversed rows of the first display area 210, a period of the first voltage control signal is T. Accordingly, as to the pixel 205a in the non-polarity reversed row of the first display area 210, a period of the corresponding first gray level voltage is also T.

As to each pixel 205b in the polarity reversed rows of the second display area 220, a period of the corresponding second voltage control signal can be defined as T2, and a period of the corresponding first voltage control signal can be defined as (T−T2), where T2 exceeds T1. Accordingly, a ratio of T2 to T can be defined as a second duty ratio corresponding to the second display area 220, and the second duty ratio exceeds the first duty ratio corresponding to the first display area. A variation range of the second duty ratio can be from 0 to 100%. Correspondingly, a period of the first sub-gray level voltage output by the data driver is also T2, and a period of the second sub-gray level voltage is also (T−T2). Therefore, as to each pixel 205b in the polarity reversed rows of the second display area 220, a duty ratio of the corresponding first sub-gray level voltage in the second gray level voltage is the same with the second duty ratio, and a variation range of the duty ratio of the corresponding first sub-gray level voltage in the second gray level voltage can also be from 0 to 100%. As to each pixel 205a in the non-polarity reversed row of the second display area 220, a period of the first voltage control signal is T. Accordingly, as to the pixel 205a in the non-polarity reversed row of the second display area 220, a period of the corresponding first gray level voltage is also T.

As to each pixel 205b in the polarity reversed rows of the third display area 230, a period of the corresponding second voltage control signal can be defined as T3, and a period of the corresponding first voltage control signal can be defined as (T−T3), where T3 exceeds T2. Accordingly, a ratio of T3 to T can be defined as a third duty ratio corresponding to the third display area 230, and the third duty ratio exceeds the second duty ratio corresponding to the second display area 220. A variation range of the third duty ratio can be from 0 to 100%. Correspondingly, a period of the first sub-gray level voltage output by the data driver 23 is also T3, and a period of the second sub-gray level voltage is also (T−T3). Therefore, as to each pixel 205b in the polarity reversed rows of the third display area 230, a duty ratio of the corresponding first sub-gray level voltage in the second gray level voltage is the same with the third duty ratio, and a variation range of the duty ratio of the corresponding first sub-gray level voltage in the second gray level voltage can also be from 0 to 100%. As to each pixel 205a in the non-polarity reversed rows of the third display area 230, a period of the first voltage control signal is T. Accordingly, as to each pixel 205a in the non-polarity reversed rows of the third display area 230, a period of the corresponding first gray level voltage is also T.

As the above description, the data driver 23 sequentially outputs the first sub-gray level voltage which has an absolute value larger than that of the second sub-gray level voltage and the second sub-gray level voltage to each pixel 205b in the polarity reversed rows, such that each pixel 205b in the polarity reversed rows can be overdriven at a predetermined time period. Accordingly, the polarity reversed rows and the non-polarity reversed rows may have an approximately same brightness at a same gray level, and the “odd-even-line phenomenon” of LCD can be decreased.

Further, the data driver 23 provides the second gray level voltage with different duty ratios for the polarity reversed rows at different display areas 210, 220, 230. The display area is farther away from the data driver 23, the second gray level voltage provided to the display area has a larger duty ratios. For example, the data driver 23 provides the second gray level voltage having the second duty ratio to each pixel 205b in the polarity reversed rows at the second display area 220 and the second gray level voltage having the third duty ratio to each pixel 205b in the polarity reversed rows at the third display area 230, where, the third duty ratio exceeds the second duty ratio, and the second duty ratio exceeds the first duty ratio corresponding to the first display area 210. Thus, a period of the first sub-gray level voltage provided to each pixel 205b far away the data driver 23 is longer than a period of the first sub-gray level voltage provided to each pixel 205b adjacent to the data driver 23. Therefore, the brightness difference between the pixel 205b far away the data driver 23 and the pixel 205b adjacent to the data driver 23 may be approximately same with each other at a same gray level. This can further decrease the “odd-even-line phenomenon” of LCD.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of disclosure to the full extent indicated by the broad general meaning of the terms in which the appended claims are expressed.

What is claimed is:

1. A liquid crystal display, comprising:
a data driver;
a scanning driver; and
a pixel matrix driven by the data driver and the scanning driver, the pixel matrix comprising a plurality of first pixels positioned in non-polarity reversed rows and a plurality of second pixels positioned in polarity reversed rows;
wherein the data driver provides a first gray level voltage signal for the first pixels, and provides a second gray level voltage signal for the second pixels, the second gray level voltage signal includes a first sub-gray level voltage and a second sub-gray level voltage which are sequentially outputted to the second pixels, an absolute value of the first sub-gray level voltage is greater than that of the second sub-gray level voltage, and the absolute value of the second sub-gray level voltage is the same with that of the first gray level voltage signal.

2. The liquid crystal display of claim 1, wherein the second gray level voltage signal has at least two different time periods at the first sub-gray level voltage for driving the second pixels in different polarity reversed rows.

3. The liquid crystal display of claim 2, wherein the polarity reversed row which receives the second gray level voltage signal having a longer time period at the first sub-gray level voltage is farther away the data driver than the polarity reversed row which receives the second gray level voltage signal having a shorter time period at the first sub-gray level voltage.

4. The liquid crystal display of claim 3, wherein a ratio of an absolute value difference between the first sub-gray level voltage and the second sub-gray level voltage to an absolute value of the second sub-gray level voltage is 20%.

5. The liquid crystal display of claim 4, further comprising a timing controller; the timing controller provides a first voltage control signal to control the data driver to output the first gray level voltage signal to each first pixels, and sequentially provides a second voltage control signal and a first voltage control signal to control the data driver to sequentially output the first sub-gray level voltage and the second sub-gray level voltage to each second pixel.

6. The liquid crystal display of claim 5, wherein a duty ratio of the second voltage control signal is the same as the duty ratio of the first sub-gray level voltage.

7. The liquid crystal display of claim 6, further comprising a gamma voltage generating circuit configured to provide a plurality of first gamma voltages to the data driver in response to the first voltage control signal, and provide a plurality of second gamma voltages to the data driver in response to the second voltage control signal.

8. The liquid crystal display of claim 7, wherein for driving the second pixels, the data driver receives the second gamma voltage and the first gamma voltage sequentially, and outputs the first sub-gray level voltage in response to the second gamma voltage and the second sub-gray level voltage in response to the first gamma voltage respectively; for driving the first pixels, the data driver receives the first gamma voltage and outputs the first gray level voltage signal in response to the first gamma voltage.

9. A liquid crystal display, comprising:
a pixel matrix comprising a plurality of first pixels positioned in non-polarity reversed rows and a plurality of second pixels positioned in polarity reversed rows; and
a data driver being configured for providing a first gray level voltage signal for driving the first pixels and a second gray level voltage signal for driving the second pixels;
wherein the second gray level voltage signal comprises a first sub-gray level voltage and a second sub-gray level voltage sequentially outputted for driving each second pixel at one frame, an absolute value of the first sub-gray level voltage is greater than that of the second sub-gray level voltage for over-driving each second pixel, and the second gray level voltage signal has different time periods at the first sub-gray level voltage for the second pixels which are different far away the data driver.

10. The liquid crystal display of claim 9, wherein the polarity reversed row which receives the second gray level voltage signal having a longer time period at the first sub-gray level voltage is farther away the data driver than the polarity reversed row which receives the second gray level voltage signal having a shorter time period at the first sub-gray level voltage.

11. The liquid crystal display of claim 9, wherein the pixel matrix are divided into at least two display areas, each display area comprises at least one polarity reversed row, a duty ratio of the first sub-gray level voltage is same in each display area, and in different display areas, the duty ratio of the first sub-gray level voltage becomes more and more great as the display area being farther away the data driver.

12. The liquid crystal display of claim 11, wherein a ratio of an absolute value difference between the first sub-gray level voltage and the second sub-gray level voltage to an absolute value of the second sub-gray level voltage is about 20%.

13. The liquid crystal display of claim 12, further comprising a timing controller; the timing controller provides a first voltage control signal to control the data driver to output the first gray level voltage signal to each first pixels, and sequentially provides a second voltage control signal and a first voltage control signal to control the data driver to sequentially output the first sub-gray level voltage and the second sub-gray level voltage to each second pixel.

14. The liquid crystal display of claim 13, wherein a duty ratio of the second voltage control signal is same as that of the first sub-gray level voltage.

15. The liquid crystal display of claim 14, further comprising a gamma voltage generating circuit configured to provide a plurality of first gamma voltages to the data driver in response to the first voltage control signal, and provide a plurality of second gamma voltages to the data driver in response to the second voltage control signal.

16. The liquid crystal display of claim 15, wherein for driving the second pixels, the data driver receives the second gamma voltage and the first gamma voltage sequentially, and outputs the first sub-gray level voltage in response to the second gamma voltage and the second sub-gray level voltage in response to the first gamma voltage respectively; for driving the first pixels, the data driver receives the first gamma voltage and outputs the first gray level voltage signal in response to the first gamma voltage.
